(19) United States
(12) Patent Application Publication
(10) Pub. No.: US 2024/0160490 A1
(43) Pub. Date: May 16, 2024

(54) TRANSPILATION-ORIENTED DECISIONS IN HYBRID QUANTUM-CLASSIC WORKLOAD ORCHESTRATION

(71) Applicant: Dell Products L.P., Round Rock, TX (US)

(72) Inventors: Rômulo Teixeira de Abreu Pinho, Niteroi (BR); Miguel Paredes Quiñones, Campinas (BR)

(21) Appl. No.: 18/054,565

(22) Filed: Nov. 11, 2022

(51) Int. Cl. G06F 9/50; G06N 10/60

(52) U.S. Cl. CPC G06F 9/505; G06N 10/60

(57) ABSTRACT

Transpilation oriented decisions in selecting quantum systems for quantum workload execution are disclosed. A training dataset is generated by collecting data related to transpilation process and related to characteristics of quantum systems. A machine learning model is trained to generate an estimate or to infer at least transpilation metrics from a high-level quantum workload. The output of the machine learning model allows a quantum system to be selected from among multiple quantum systems.

### FIELD OF THE INVENTION

Embodiments of the present invention generally relate to quantum computing and more specifically to hybrid classical-quantum application orchestration. More particularly, at least some embodiments of the invention relate to systems, hardware, software, computer-readable media, and methods for selecting quantum systems for quantum circuit execution based on estimated or inferred transpilation metrics.

### BACKGROUND

Although quantum computing is slowly becoming more widely available, there is no consensus about the specific architectures and technologies that will be dominant in the market. However, there is a general feeling that classical computing will be an integral part of quantum workloads from control, management, and algorithmic perspectives.

Today, hybrid algorithms that combine quantum and classical computing by design illustrate the advantage of quantum computing. These types of hybrid algorithms are expected to form the basis of hybrid workloads in the future.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a computing environment that includes classical computing systems and quantum systems or quantum architectures;

FIG. 1B discloses aspects of an orchestration configured at least to orchestrate the classical portion and the quantum portion of a hybrid workflow and to select a quantum system for executing the quantum portion;

FIG. 2 discloses aspects of a training stage, including generating or building the training dataset and training the machine learning model;

FIG. 3 discloses aspects of transpilation and aspects of collecting transpilation metrics and other data;

FIG. 4 discloses additional aspects of a dictionary T;

FIG. 5 discloses aspects of generating quantum circuits;

FIG. 6 discloses aspects of a dictionary for the collected transpilation data or metrics;

FIG. 7 discloses aspects of an execution stage that selects a quantum system based on estimates that include transpilation estimates;

FIG. 8 discloses an example of pseudocode or a method for selecting a quantum system for executing a quantum portion of a hybrid workload; and

FIG. 9 discloses aspects of a computing device, system, or entity.

### DETAILED DESCRIPTION OF SOME EXAMPLE EMBODIMENTS

Embodiments of the present invention generally relate to hybrid classical-quantum systems and related workloads (e.g., applications, operations), which may be referred to herein as hybrid workloads. More particularly, at least some embodiments of the invention relate to systems, hardware, software, computer-readable media, and methods for selecting a quantum system for a hybrid workload in a manner that accounts for transpilation operations.

Hybrid workloads involve the use of both classical computing systems and quantum computing systems. More specifically, a hybrid workload may include a classical portion and a quantum portion. While the classical computing systems and the quantum computing systems cooperate to execute a hybrid workload, the characteristics of the quantum systems used to execute the quantum portions of the hybrid workloads can vary.

Orchestrating a hybrid workload may include the ability to select the quantum system (also referred to as a quantum architecture). Selecting a particular quantum system from among available quantum workloads, however, is a challenging task. Aspects of the quantum systems related to reliability, execution time, transpilation, and costs of operation may determine which quantum system is the most beneficial for each type of quantum workload. Embodiments of the invention relate to selecting a specific quantum system in a manner that accounts for one or more of these aspects, including transpilation aspects.

When selecting a quantum system for a quantum portion of a hybrid workload, embodiments of the invention consider the transpilation characteristics. Transpilation is a process that converts a quantum circuit (e.g., the equivalent of an algorithm in a high-level programming language) into another circuit that satisfies the hardware restrictions of the target quantum system (e.g., the equivalent of machine code using native instructions and registers).

Transpilation is implemented or performed with classical algorithms and heuristics that try to find a good mapping between the “high-level” quantum circuit and its “hardware-oriented” counterpart. The output of the transpilation operation may contain more steps than the original circuit and transpilation algorithms attempt to satisfy criteria such as increased circuit reliability and reduced execution time while considering underlying hardware constraints. Further, transpiling a circuit for one quantum system may not be suitable for another quantum system. In other words, transpilation is performed for the characteristics of specific quantum systems or architectures.

Transpilation algorithms may contain parameters that indicate the desired level of optimization to obtain the target circuit. The higher the optimization level, the longer transpilation takes to execute. Transpilation is a process that has many steps and, in some cases, in order to get a quick solution, steps related to the optimization part are neglected, because those steps increase the time required to transpile the circuit. When selecting a quantum system to run a quantum workload, transpilation requirements such as transpilation time is considered in embodiments of the invention.

Choosing an inadequate quantum system for a quantum workload may lead to inaccuracies and inefficiencies in the execution of the quantum workload. Incorrect decisions result in lost time and increased cost. Embodiments of the invention relate to training and deploying a machine learning model (or models) that allow transpilation outcomes to be predicted without performing transpilation. Determining transpilation metrics, however, allows the transpilation process to be considered when selecting a quantum system for executing the quantum portion of a hybrid workload and may allow a quantum system to be selected that will execute a given quantum circuit more effectively and efficiently compared to other quantum systems.

Embodiments of the invention further relate to selecting a quantum system to execute a quantum circuit in the context of orchestrating a hybrid workload. Selecting the quantum system using inferred or estimated transpilation metrics accounts for the impact of the transpilation process from the perspective of the target quantum system and the transpilation algorithms.

Embodiments of the invention may include a training stage and an execution stage. During the training stage, a training dataset may be built or generated that includes attributes related to transpilation executions performed with respect to multiple quantum systems. For example, features of the high-level quantum circuit are collected. This includes capturing qubit connectivity and operations between the qubits. Features of the target quantum system related to the transpilation process are also collected. These features may include qubit connectivity, inherent reliability of hardware components, inherent execution time of hardware components, and the like.

Features related to the parameters of the transpilation algorithm/heuristics used in each transpilation, such as the optimization level, are also collected.

Ground-truth metrics from the transpilation executions are also collected. These metrics may include transpilation execution time, estimated noise of the resulting hardware-oriented circuit, estimated execution time of the resulting hardware-oriented circuit, generic features of the resulting hardware-oriented circuit, and the like.

This data may be included in a training dataset. Once the training dataset is generated, a machine learning model may be trained using the training dataset to learn relationships between the input features and the ground-truth metrics.

The execution stage includes employing a trained machine learning model to estimate, for relevant (e.g., available) quantum systems, the transpilation time, the accumulated noise of the target circuit, and the like for each transpilation parameter available. Using the output or inference of the machine learning model, a quantum system can be selected. In particular, the quantum system that best satisfies a relevant SLA (service level agreement) may be selected for the hybrid workload. The SLA may include SLOs (service level objectives). Example objectives may include total execution time, transpilation time, or the like.

A hybrid orchestration engine, which is configured to orchestrate hybrid workflows in a system that includes both classical computing systems and quantum systems, also facilitates the selection of the quantum system for a specific quantum portion of a hybrid workload. The hybrid orchestration engine, which may include a machine learning model, allows a quantum system to be selected from among multiple quantum systems based on, for example, the transpilation characteristics of each of the quantum systems. More specifically, the machine learning model may be trained to estimate transpilation characteristics, which can be used in selecting a quantum system prior to performing the actual transpilation process.

A machine learning base approach disclosed herein learns the relationship between input features related to the quantum circuit, the target quantum systems, and the transpilation parameters, and the output metrics of the transpiled circuit, such as noise and execution time, and allows metrics to be predicted directly from the input quantum circuit. Embodiments of the invention also learn the relationship between the input features related to the quantum circuit, the target quantum systems, and the transpilation parameters, and the metrics related to the efficiency of the transpilation algorithms/heuristics themselves, such as transpilation execution time.

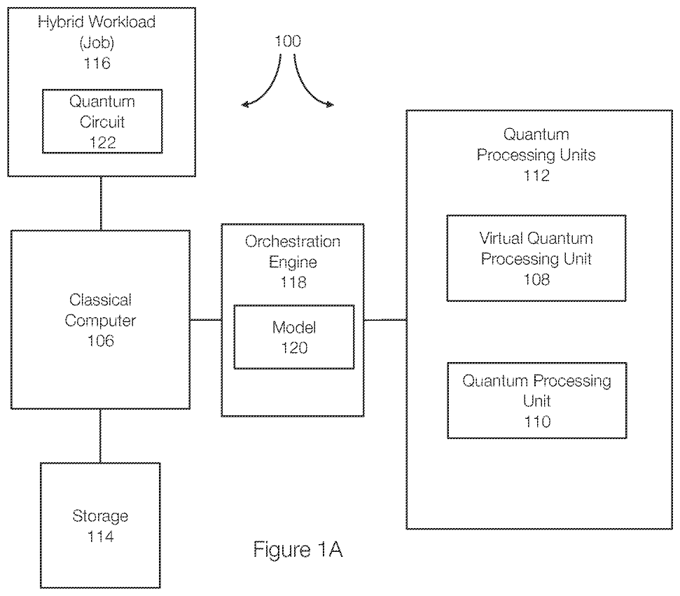

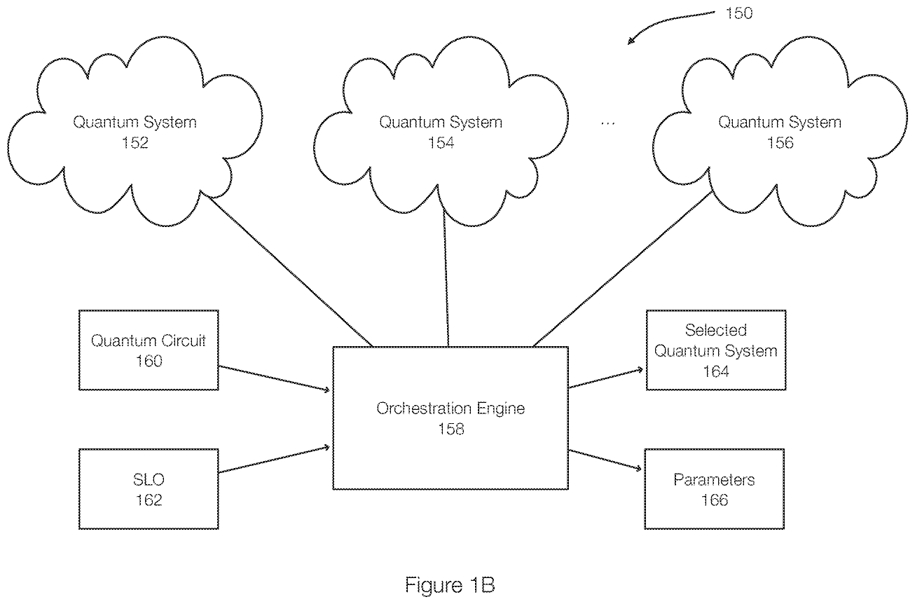

FIG. 1A discloses aspects of a computing environment that includes classical computing system(s) and quantum systems, which may be referred to as quantum processing units (QPUs). The computing system 100 is configured to perform hybrid classical-quantum computing operations or hybrid workloads, which may include classical computing processes and quantum processes. The quantum processing units 112 which includes: virtual quantum processing unit 108 and quantum processing unit 110, may participate in executing the hybrid workload 116.

The orchestration engine 118 may be configured to coordinate the operation of a classical computing portion of the hybrid application 116 (the portion of the hybrid application 116 executing in the classical computer 106) and a quantum portion (the portion of the hybrid workload 116 performed in the quantum processing units 112).

FIG. 1A illustrates a classical computer 106 (an example of a classical processing or computing unit) configured to execute a hybrid workload 116 or other job. The computer 106 may represent a stand-alone machine, a server computer, a server cluster, a computing system including servers, a container, a virtual machine, or the like. The computer 106 may be implemented in an on-premise system or in the cloud (e.g., a datacenter). The computer 106 may include one or more processors, memory, and other circuitry. The computer 106 may also be associated with a storage 114, such as a volume, a storage array, a disk drive, or the like or combination thereof.

The computer 106 may receive the hybrid workload 116 as input. The orchestration engine 118 may coordinate the execution of the classical portion of the hybrid workload 116 and the quantum portion of the hybrid workflow 116. The quantum portion of the hybrid workload 116 may include a quantum circuit 122. T

The quantum processing units 112 may include virtual and/or physical (real) quantum processing units. The runtime characteristics, infrastructure requirements, and licensing models or costs of the quantum processing units 112 units vary. When executing the hybrid workload 116 and execution of the quantum job (e.g., the quantum circuit 122) is required, the quantum job may be performed in one of the quantum processing units 112. Further, multiple iterations (shots) may be performed in the selected quantum processing unit at least because the outputs of quantum processing units are probabilistic in nature and often generate a probability distribution. When the quantum job is completed, results may be returned to the hybrid workload 116 (e.g., an application) or to the computer 106.

The orchestration engine 118 includes or has access to a model 120 that has been trained to select a quantum processing unit from among the quantum processing units 112 to execute the quantum job, which may be the quantum circuit 122. In particular, the model 120 identifies a specific quantum processing unit, such as the quantum processing unit 110, based at least on predicted or estimated transpilation aspects or characteristics of the quantum circuit 122. The orchestration engine 118 may also consider other aspects of quantum execution, such as quantum execution time or the like.

FIG. 1B discloses aspects of an orchestration configured at least to orchestrate the classical portion and the quantum portion of a hybrid workflow and to select a quantum system for executing the quantum portion (or quantum portions). In FIG. 1B, the orchestration engine 158 is configured to select a quantum system from among available quantum systems 150, which are represented by the quantum systems 152, 154, and 156. As illustrated, the quantum systems 152, 154, and 156 (e.g., QPU₁ . . . QPUₙ) may be remote from the orchestration engine 158 and may be cloud-based.

In this example, the orchestration engine (0) 158 receives a quantum circuit c 160 and an SLO (or SLA) 162 as input. The orchestration engine 158 (or more specifically a machine learning model included in or associated with the orchestration engine 158) outputs a selected quantum system 164 (v)QPU₁ and parameters t(p) 166 of the selected quantum system.

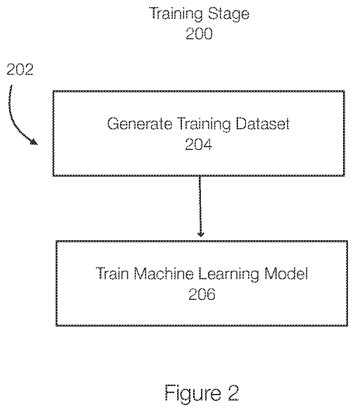

FIG. 2 discloses aspects of a training stage. Generally, the training stage 200 includes a method 202. The method 202 includes generating 204 a training dataset and training 206 one or more machine learning models. Multiple models may be generated to account for different transpilation algorithms and/or different parameters for each of the transpilation algorithms.

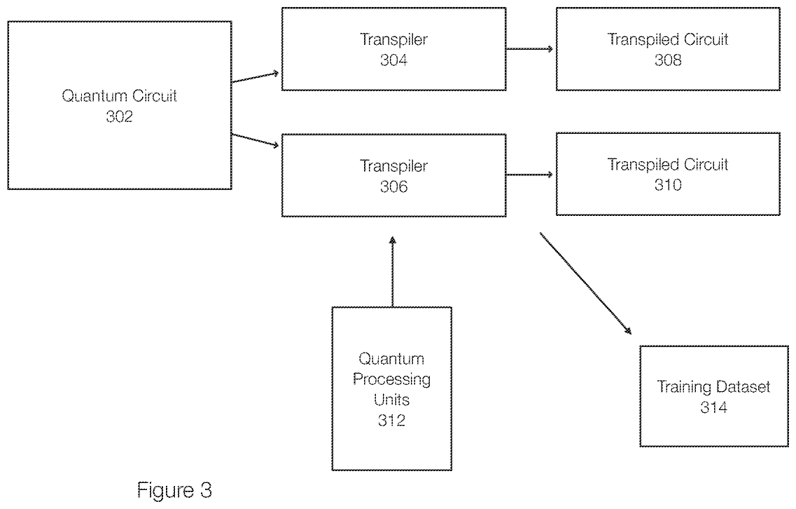

FIG. 3 discloses aspects of transpilation in the context of generating a training dataset. In this example, a set of quantum processing units 312 are selected or identified. Thus, the quantum processing units 312 are available for executing the quantum portions of hybrid workloads. When generating the training dataset, a quantum circuit 302 may be transpiled using multiple transpilers, represented by the transpilers 304 and 306, to generate transpiled circuits 308 and 310 and to generate transpilation metrics.

More specifically, the quantum circuit 302 may be transpiled by the transpiler 304 for each of the quantum processing units 312 and by the transpiler 306 for all of the quantum processing units 312. As previously stated, the transpilation may differ based on the target quantum processing unit. Data associated with the transpilation illustrated in FIG. 3 may include transpilation metrics, characteristics of the quantum hardware, and the like or combination thereof may be included in the training dataset 314.

Transpilation is performed by the transpilers 304 and 306 to map the quantum circuit 302 to each of physical systems included in the quantum processing units 312. One of the challenges in transpiling the quantum circuit 302 is to map the logical and physical qubits such that two-qubit operations are carried out by neighbor qubits on the target quantum system. One example of a two-qubit operation is the CNOT gate, which entangles the two qubits.

Transpilation also considers other restrictions such as the total execution time of the transpiled circuit and the accumulated error. Both of these metrics can be obtained from calibration data made available by the quantum systems and are directly associated with the physical qubits.

During the training stage, the following features may be (or portion thereof) collected for each target quantum system and included in the training dataset 314:
[symbol] : The connectivity or adjacency matrix that captures the topology (i.e., neighborhood information) of the physical qubits;
[symbol] ₜ: The adjacency matrix [symbol] enriched with crosstalk error information between qubits;
T: The expected execution time of each qubit.
CNOT_{ER}: The adjacency matrix [symbol] enriched with CNOT error rate between each pair of qubits;
CNOT_{ET}: The adjacency matrix enriched with CNOT execution time between each pair of qubits;
T₂: The transverse relaxation time for each processor qubit, which measures the decoherence time of a qubit;
T₁: The longitudinal relaxation time for each processor qubit, which measures the time it takes for a qubit's excited state to spontaneously decay to the ground state;
E_{Ro}: The readout error for each processor qubit.

Qubit-wise features may be represented as vectors and matrices may be linearized into their equivalent linearized representation. In one example, these features, except for T₁ and T₂, are included in a vectorized set Fₕ, where h identifies the quantum system. The features T₁ and T₂ are used, in one example, as a direct criterion for eliminating a quantum system if a transpiled circuit has a longer running time compared with T₁ and T₂ and are stored in a dictionary [symbol] .

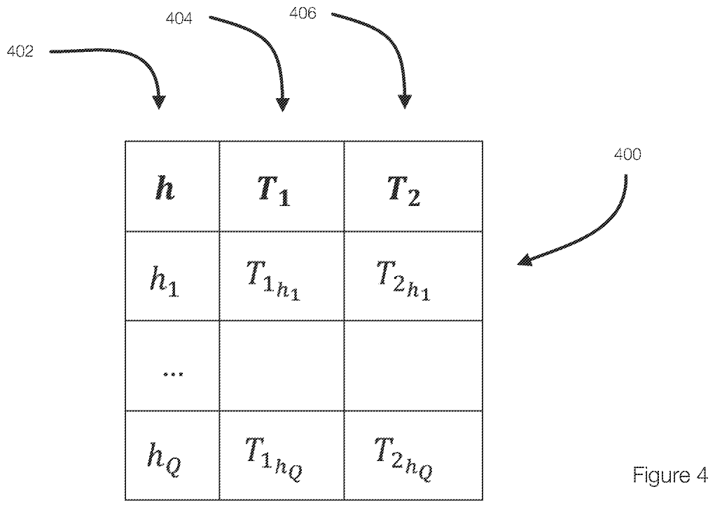

FIG. 4 discloses additional aspects of a dictionary [symbol] . The dictionary 400 ( [symbol] ) includes auxiliary information about coherence data (relaxation times) for each of the available quantum systems. The dictionary 400 can be updated to add/remove entries. The dictionary 400 includes a hardware key 402 (h) and associated relaxation times 404 (T₁) and 406 (T₂). More specifically, the relaxation times of each quantum system is an entry in the dictionary 400. The key 402 may be a string representation of the quantum system's name.

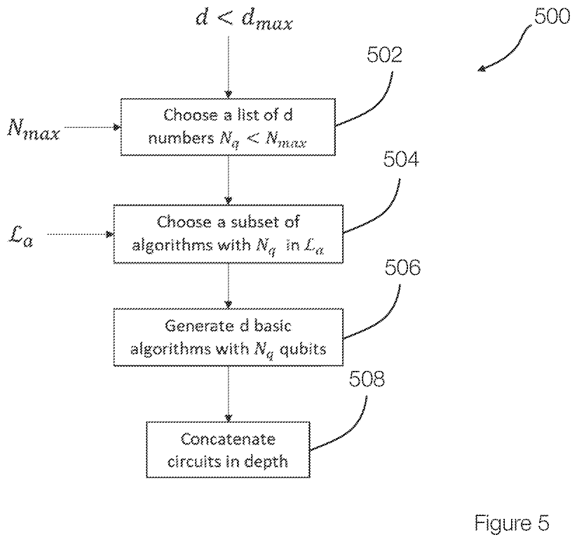

FIG. 5 discloses aspects of generating quantum circuits. In the context of the training stage, quantum circuits are generated in order to obtain data used in training the machine learning model. In the method 500, quantum circuits are generated. In one example the quantum circuits are generated using random combinations of basic quantum algorithms, such as amplitude amplification algorithms, phase estimation algorithms, variational algorithms, and the like or combinations thereof. This has the advantage of creating quantum circuits that more closely resemble real applications at least because high-level algorithms generally use these basic algorithms as part of their quantum circuits. In addition, these algorithms may impose more realistic relationships between the number of qubits and the circuit depth comparted to arbitrarily varying the depth of random quantum circuits.

One parameter for generating quantum circuits in the method 500 is the number of qubits. The number of qubits is tied to the architectures of the quantum systems where the quantum circuits are executed or performed. The method 500 thus receives the maximum number of qubits on available hardware (Nₘₐₓ), a list of basic algorithms ( [symbol] ₐ), and a maximum number of concatenated algorithms (dₘₐₓ).

The method 500 chooses 502 a list of d numbers where the number of qubits is less than the maximum number of qubits. A subset of algorithms are selected 504 from the set of algorithms [symbol] ₐ, using the number of qubits N_{q}. Next, d algorithms are generated 506 with N_{q} qubits. The circuits are then concatenated 508 in depth. The method 500 thus generates random quantum circuits that are suitable for the available quantum systems.

After the quantum circuits are generated by the method 500, circuit related features are collected from or for each of the quantum circuits. The features include:
N: the number of qubits, limited by Nₘₐₓ;
N_{CNOT}: the total number of CNOT operations in the circuit; and
[symbol] _{CNOT}: an adjacency matrix containing the number of CNOT operations between each pair of qubits {qᵢ, qⱼ}, where qᵢ is the control qubit and qⱼ is the target qubit.

These features may compose a vectorized set: [symbol] _{c}.

In one example, the machine learning model will be trained to estimate transpilation metrics that may influence orchestration decisions across available quantum systems. As a result, transpilation features and outcomes are collected and included in the training dataset. With the quantum circuits that have been generated, a transpilation instance is run for each of the available or target quantum systems. Thus, for each random circuit c, the circuit is transpiled for each of the quantum systems h.

Each transpilation instance includes or uses a transpilation algorithm a that may require execution parameters p. For example, the parameters of a transpiler may include, among other parameters, an optimization level. The optimization level may determine which heuristic (algorithm a) is used. Heuristics may determine how much optimization to perform on the target circuit. Higher optimization levels lead to longer transpilation times. Other parameters may include a maximum running time or a maximum number of iterations.

For each quadruplet {a, p, h, c}, the transpilation is executed to obtain the following service level objective (SLO) metrics, which are examples of ground truth:
Tₜ: Transpilation time;
D: Final circuit depth;
Tₜ: Estimated circuit execution time, based on calibration data obtained from the quantum system;
R: Estimated circuit reliability as a multiplication of the error individual gates, based on calibration data obtained from the quantum system.

The transpilation output metric may be represented as a vectorized set: [symbol] _{a, p, h, c}. Because transpilation is executed in classical computing systems and calibration data is available from the quantum systems (e.g., provided by quantum system vendors), quantum hardware is not required to generate this data. All SLO metrics related to the quantum circuits can be obtained or generated from estimates. In one embodiment, if the budget is not adequate, random sampling can be used for each quadruplet {a, p, h, c} at the cost of generating less data for training purposes.

This data is collected and arranged, in one example, in a dictionary D, which is an example of a training data set. The keys to the dictionary will be a quadruplet {a, p, h, c}. In this example, a identifies the transpilation algorithm, p identifies the parameters used in one transpilation instance, h identifies the quantum system or architecture, and c identifies a quantum circuit.

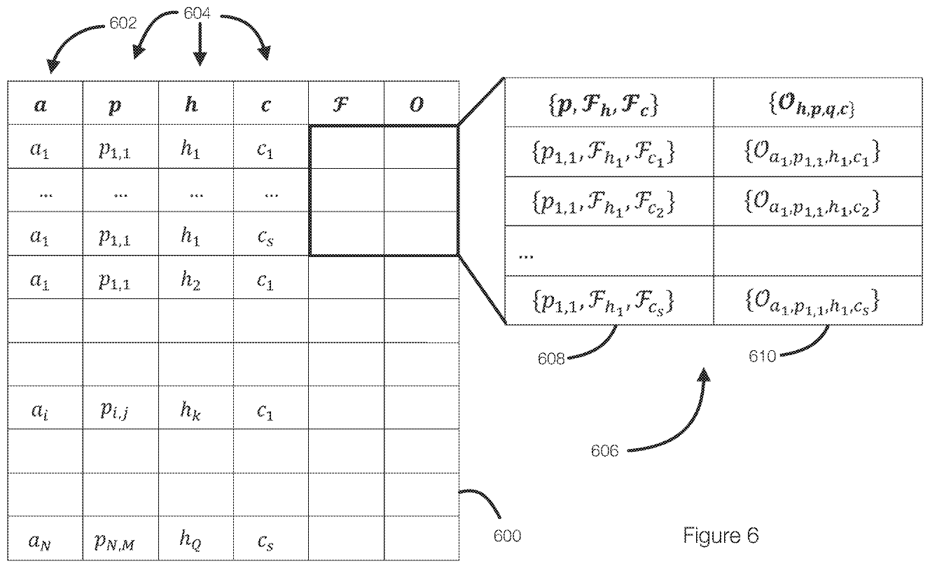

FIG. 6 discloses aspects of a dictionary for the collected transpilation data or metrics. The dictionary 600 includes a model key 602 and data keys 604. The transpilation data 606 includes input data 608 and output data 610.

More specifically, each entry of the dictionary 600 is associated with a collection of transpilation instances resulting from transpiling the random quantum circuits previous generated and obtaining the output metrics. The entries are associated with a table of input features (input 608) and output metrics (output 610).

Using the dictionary 600, which is an example of a training dataset, a machine learning model Mᵢ can be trained using the dictionary entries with a key aᵢ. In one example, a machine learning model is trained in a supervised manner to learn optimal parameters θᵢ by fitting a function ƒᵢ to the data such that ƒᵢ (θ): {p, h, [symbol] ₕ, [symbol] _{c}} →{ [symbol] _{a,p,h,c}} After training, it may be possible to discard the transpilation instance data, which is replaced by the trained machine learning model.

The machine learning model may be, by way of example only, a convolutional neural network, recurrent neural network, regression tree, or the like. The machine learning model learns associations between the input features and the output metrics such that the transpilation metrics can be inferred. These inferences may be used by an orchestration engine to select a quantum system.

After collecting training data and training multiple machine learning models, the transpilation metrics for an input quantum circuit can be estimated for inferred using the machine learning models. More specifically, the orchestration engine can use the machine learning models and SLA constraints to select the best quantum system for a quantum circuit.

The training dataset generated during the training stage includes metrics related to transpilation and/or circuit execution and may account for other aspects of quantum execution such as accumulated error, and the like. The training stage allows a model to be trained that is able to account not only for quantum circuit execution time, but also transpilation time. The machine learning model is trained to account for transpilation time, various parameters including optimization parameters, and the like.

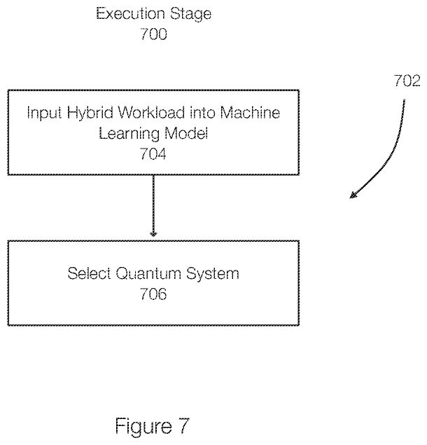

FIG. 7 discloses aspects of an execution stage. The execution stage 700 performs a method 702. The method 702 includes inputting 704 a hybrid workload into a trained machine learning model. More specifically, the input may include features such as a transpilation algorithm, parameters, a quantum system, and a quantum circuit. The input data may include, for example, the input 608 illustrated in FIG. 6. The model operates on the input and generates an output (e.g., the output 610). The output is used to select 706 a quantum system from a set of quantum systems.

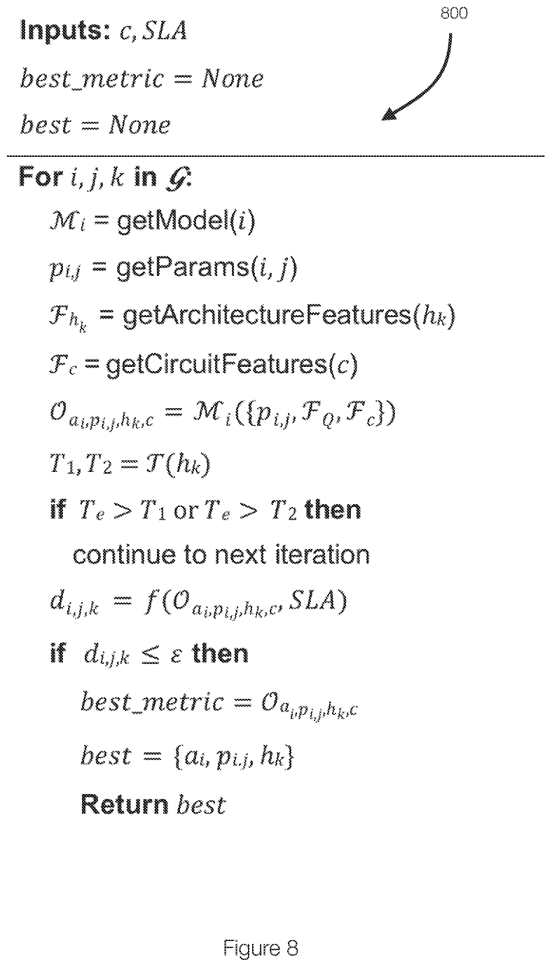

FIG. 8 discloses aspects of selecting a quantum system for a quantum circuit using machine learning models. The pseudocode or method 800 loops through a set [symbol] ={(i, j, k): i=1 . . . N,j=1 . . . M,k=1 . . . . Q}, which are related to the dictionary 600 and retrieves the associated model M 1. Next, the transpilation parameters p=p_{i,j} and the quantum system features [symbol] ₕ_{ₖ} associated with the quantum system hₖ are retrieved. In one example, just-in-time calibration data may be obtained from the quantum system during the execution of the method 800. Alternatively, the calibration data may be stored and retrieved in advance.

Next, circuit features [symbol] _{c} are obtained from quantum circuit c. With {p, [symbol] ₕ, [symbol] _{c}}, the model Mᵢ can be invoked to generate an inference or estimates of the transpilation metrics [symbol] ₐ_{ᵢ}_{,p}_{_{i,j}}_{,h}_{ₖ}_{,c}.

In one example, a quantum system is selected using a distance measurement. The distance may be defined as: d_{i,j,k}=d ( [symbol] ₐ_{ᵢ}_{,p}_{_{i,j}}_{,h}_{ₖ}_{,c},SLA). The distance measures how far the estimated metrics are from the desired SLA metrics. In one example, a quantum system may satisfy the SLA requirements if the computed distance is within a threshold or tolerance distance ε.

In one example, a selected quantum system identified by the orchestration engine may have a configuration that is represented by a triplet {aᵢ,p_{i,j}, hₖ}, where aᵢ is a transpilation algorithm, p_{i,j} are the parameters of the transpilation algorithm, and hₖ is the quantum system. After looping through all of the possible configurations in the method 800, the method 800 may return the first quantum system that satisfies the distance restriction or tolerance ε. This suggests that quantum system identified by the method 800 satisfies the requirements SLA requirements. However, a different quantum system may be better or be closer in terms of distance d.

As previously stated, the times T₁ and T₂ have been collected for the quantum system hₖ and stored in a dictionary. If the element Tₑ of [symbol] ₐ_{ᵢ}_{,p}_{_{i,j}}_{,h}_{ₖ}_{,c}, which estimates the execution time of the quantum circuit on hₖ, is above the decoherence or relaxation times of the quantum system hₖ, the configuration that generated [symbol] ₐ_{ᵢ}_{,p}_{_{i,j}}_{,h}_{ₖ}_{,c}, is discarded. If no configuration satisfies the SLA constraints, the method 800 returns None.

The algorithm above can thus be integrated with an overall hybrid workload orchestration process that includes classical operations and quantum operations. It should be noted that new quantum architectures, transpilation algorithms, and parameters can easily be added. Because the estimation and optimization steps have been decoupled, training a machine learning model for each new architecture to be considered in the orchestration is sufficient to select a quantum system. In principle, each model [symbol] ᵢ can be updated by following the data collection steps for a new architecture Q+1 (or a new transpilation algorithm, or new transpilation parameters, provided the structure of the model input does not change) and training [symbol] ᵢ for additional epochs with new data.

Embodiments of the invention train a machine learning model that can predict post-transpilation metrics directly from the high-level quantum circuit representation and predict metrics of the transpilation process. The machine learning model may be integrated into an orchestration pipeline to aid in determining which quantum system to select for executing a quantum workload.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, hybrid workload orchestration operations, transpilation operations, transpilation related estimation or inference operations, quantum system selection operations, or the like or combination thereof. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method comprising: inputting features of a quantum workload into a machine learning model that has been trained to estimate at least transpilation metrics, receiving an output from the machine learning model, and selecting a quantum system for executing the quantum workload based on the output of the machine learning model.

Embodiment 2. The method of embodiment 1, wherein the features include parameters of a transpilation algorithm, features of a quantum system, and features of the quantum workload.

Embodiment 3. The method of embodiment 1 and/or 2, wherein the output includes metrics including a transpilation time and/or an estimated circuit execution time.

Embodiment 4. The method of embodiment 1, 2, and/or 3, further comprising selecting the quantum system based on whether the output is within a tolerance of service level objective constraints.

Embodiment 5. The method of embodiment 1, 2, 3, and/or 4, wherein the tolerance is defined as a distance between the output and a ground truth.

Embodiment 6. The method of embodiment 1, 2, 3, 4, and/or 5, further comprising inputting the features into multiple machine learning models, wherein each of the machine learning models is associated with a transpilation algorithm.

Embodiment 7. The method of embodiment 1, 2, 3, 4, 5, and/or 6, further comprising training the machine learning model.

Embodiment 8. The method of embodiment 1, 2, 3, 4, 5, 6, and/or 7, further comprising: selecting target quantum systems, wherein features including one or more of: a connectivity matrix, a connectivity matrix enriched with cross talk information between qubits, expected execution time of each qubit, a connectivity matrix enriched with CNOT error rates between each pair of qubits, a connectivity matrix enriched with CNOT execution times between each pair of qubits, a transverse relaxation time, a longitudinal relaxation time, and/or a readout error are collected for each of the target quantum systems, generating random quantum circuits and collecting transpilation metrics for the random quantum circuits for each of the selected target quantum systems, and including the collected features and the transpilation metrics in the training dataset.

Embodiment 9. The method of embodiment 1, 2, 3, 4, 5, 6, 7, and/or 8, further comprising looping through multiple configurations to select the quantum system, wherein the quantum system is a first quantum system to satisfy a tolerance.

Embodiment 10. The method of embodiment 1, 2, 3, 4, 5, 6, 7, 8, and/or 9, further comprising training the machine learning model to learn a relationship between input features related to a quantum circuit, target quantum systems, and transpilation metrics to output metrics of a transpiled quantum circuit.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term engine, client, module, portion or component may refer to software objects or routines that execute on the computing system or in a quantum environment. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein. Quantum hardware are also operable to execute quantum instructions.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

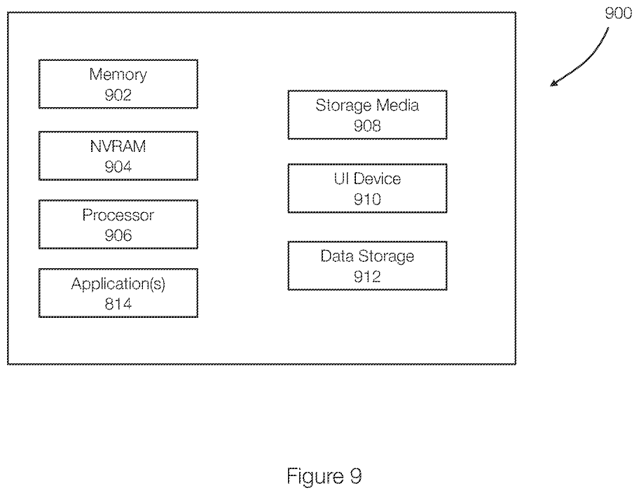

With reference briefly now to FIG. 9, any one or more of the entities disclosed, or implied, by the Figures and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random-access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid-state device (SSD) storage. As well, one or more applications 914 may be provided that comprise instructions executable by one or more hardware processors 906 to perform any of the operations, or portions thereof, disclosed herein. The computing device 800 may also include or have access to multiple quantum systems, whether real or virtual, and/or other accelerators.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
inputting features of a quantum workload into a machine learning model that has been trained to estimate at least transpilation metrics;
receiving an output from the machine learning model; and
selecting a quantum system for executing the quantum workload based on the output of the machine learning model.

2. The method of claim 1, wherein the features include parameters of a transpilation algorithm, features of a quantum system, and features of the quantum workload.

3. The method of claim 1, wherein the output includes metrics including a transpilation time and/or an estimated circuit execution time.

4. The method of claim 1, further comprising selecting the quantum system based on whether the output is within a tolerance of service level objective constraints.

5. The method of claim 4, wherein the tolerance is defined as a distance between the output and a ground truth.

6. The method of claim 1, further comprising inputting the features into multiple machine learning models, wherein each of the machine learning models is associated with a transpilation algorithm.

7. The method of claim 1, further comprising training the machine learning model.

8. The method of claim 7, further comprising:
selecting target quantum systems, wherein features including one or more of: a connectivity matrix, a connectivity matrix enriched with cross talk information between qubits, expected execution time of each qubit, a connectivity matrix enriched with CNOT error rates between each pair of qubits, a connectivity matrix enriched with CNOT execution times between each pair of qubits, a transverse relaxation time, a longitudinal relaxation time, and/or a readout error are collected for each of the target quantum systems;
generating random quantum circuits and collecting transpilation metrics for the random quantum circuits for each of the selected target quantum systems; and
including the collected features and the transpilation metrics in the training dataset.

9. The method of claim 1, further comprising looping through multiple configurations to select the quantum system, wherein the quantum system is a first quantum system to satisfy a tolerance.

10. The method of claim 1, further comprising training the machine learning model to learn a relationship between input features related to a quantum circuit, target quantum systems, and transpilation metrics to output metrics of a transpiled quantum circuit.

11. A non-transitory storage medium having stored therein instructions that are executable by one or more hardware processors to perform operations comprising:
inputting features of a quantum workload into a machine learning model that has been trained to estimate at least transpilation metrics;
receiving an output from the machine learning model; and
selecting a quantum system for executing the quantum workload based on the output of the machine learning model.

12. The non-transitory storage medium of claim 11, wherein the features include parameters of a transpilation algorithm, features of a quantum system, and features of the quantum workload.

13. The non-transitory storage medium of claim 11, wherein the output includes metrics including a transpilation time and/or an estimated circuit execution time.

14. The non-transitory storage medium of claim 11, further comprising selecting the quantum system based on whether the output is within a tolerance of service level objective constraints.

15. The non-transitory storage medium of claim 14, wherein the tolerance is defined as a distance between the output and a ground truth.

16. The non-transitory storage medium of claim 11, further comprising inputting the features into multiple machine learning models, wherein each of the machine learning models is associated with a transpilation algorithm.

17. The non-transitory storage medium of claim 11, further comprising training the machine learning model.

18. The non-transitory storage medium of claim 17, further comprising:
selecting target quantum systems, wherein features including one or more of: a connectivity matrix, a connectivity matrix enriched with cross talk information between qubits, expected execution time of each qubit, a connectivity matrix enriched with CNOT error rates between each pair of qubits, a connectivity matrix enriched with CNOT execution times between each pair of qubits, a transverse relaxation time, a longitudinal relaxation time, and/or a readout error are collected for each of the target quantum systems;
generating random quantum circuits and collecting transpilation metrics for the random quantum circuits for each of the selected target quantum systems; and
including the collected features and the transpilation metrics in the training dataset.

19. The non-transitory storage medium of claim 11, further comprising looping through multiple configurations to select the quantum system, wherein the quantum system is a first quantum system to satisfy a tolerance.

20. The non-transitory storage medium of claim 11, further comprising training the machine learning model to learn a relationship between input features related to a quantum circuit, target quantum systems, and transpilation metrics to output metrics of a transpiled quantum circuit.
